(19) United States
(12) Patent Application Publication
(10) Pub. No.: US 2025/0280322 A1
(43) Pub. Date: Sep. 4, 2025

(54) CORRELATED PARAMETER INFORMATION EXCHANGE FOR NEXT GENERATION MOBILE NETWORKS

(71) Applicant: Apple Inc., Cupertino, CA (US)

(72) Inventors: Sarma V. VANGALA, Campbell, CA (US); Swaminathan BALAKRISHNAN, Los Gatos, CA (US); Babar QAISRANI, San Ramon, CA (US); Mukesh S. GUPTA, San Jose, CA (US); Erdogan DEDE, San Diego, CA (US)

(21) Appl. No.: 18/952,639

(22) Filed: Nov. 19, 2024

Related U.S. Application Data
(60) Provisional application No. 63/559,736, filed on Feb. 29, 2024.

(51) Int. Cl. H04W 28/02; H04L 1/20; H04W 52/36

(52) U.S. Cl. CPC H04W 28/0278; H04L 1/203; H04W 52/365; H04W 52/367

(57) ABSTRACT

This application regards using correlated parameter information for communication between a wireless device and a base station of a wireless network. The wireless device and/or the base station can determine a correlation exists between different parameters communicated by the wireless device to the base station. The correlation can be taken into account when determining a configuration setting for the wireless device. In some embodiments, the wireless device determines an adjusted buffer status report (BSR) value based on an amount of pending uplink data and on a power headroom report (PHR) value, and the wireless device sends the adjusted BSR value in place of an unadjusted BSR value to the base station of the wireless network. In some embodiments, the wireless device and/or the base station communicate parameter correlations to each other and use the parameter correlations to calculate adjusted parameter values in place of unadjusted parameter values.

### CROSS-REFERENCE TO RELATED APPLICATIONS

The present application claims the benefit of U.S. Provisional Application No. 63/559,736, entitled “CORRELATED PARAMETER INFORMATION EXCHANGE FOR NEXT GENERATION MOBILE NETWORKS,” filed Feb. 29, 2024, the content of which is incorporated by reference herein in its entirety for all purposes.

### FIELD

The described embodiments relate to wireless communications, including system, methods, and apparatus for determining, exchanging, and using correlated parameter information for communication between a wireless device and a base station of a wireless network.

### BACKGROUND

Newer generation, fifth generation (5G), cellular wireless networks that implement one or more 3rd Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC) or an embedded UICC (cUICC) included in the wireless device.

Wireless devices can be configured to use removable UICCs, that include at least a microprocessor and a read-only memory (ROM), where the ROM is configured to store an MNO profile, also referred to as subscriber identity module (SIM) or SIM profile, which the wireless device can use to register and interact with a cellular wireless network of an MNO to obtain access wireless services. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs, which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device communicates with a network base station of an access portion of a cellular wireless network using wireless communication protocols and configured based on parameters communicated by the network base station. In many situations where conservation of limited wireless device resources, such as battery power is important, one or more parameters communicated between the wireless device and the cellular wireless network may not account for limitations at the wireless device. There exists a need to determine correlated parameter information and to use the determined correlated parameter information to adjust communication parameters selected for communication between the wireless device and the cellular wireless network.

### SUMMARY

The described embodiments relate to wireless communications, including system, methods, and apparatus for determining, exchanging, and using correlated parameter information for communication between a wireless device and a base station of a wireless network. The wireless device and/or the base station can determine a correlation exists between different parameters communicated by the wireless device to the base station of the wireless network. The correlation can be taken into account when determining a configuration setting for the wireless device. In some embodiments, the wireless device determines, or is configured to recognize, a correlation between two distinct parameters communicated to the base station of the wireless network, e.g., between a buffer status report (BSR) value and a power headroom report (PHR) value. The wireless device can send to the base station of the wireless network an adjusted BSR value determined based on i) an amount of data pending in one or more buffers for uplink transmission and on ii) the PHR value. The adjusted BSR value can be lower than an unadjusted BSR value that would normally be sent to the base station of the wireless device in accordance with a wireless communication standard. In some embodiments, the wireless device determines an adjusted BSR value to send to the base station of the wireless network based on an amount of power available for the wireless device to use to transmit in the uplink direction. In some embodiments, the amount of power available is restricted by other computing elements of the wireless device, such as based on a thermal limitation for one or more components of the wireless device or based on a temporary high power consumption requirement for a component of the wireless device. By sending adjusted BSR values to the base station of the wireless network, the wireless device can better align an available amount of transmit power to resources granted by the base station to the wireless device. In some embodiments, the wireless device determines a correlation between two or more unadjusted parameters used for communication between the wireless device and a base station of the wireless network and sends to the base station of the wireless network a message indicating the determined correlation. The wireless device can send one or more adjusted parameter values to the base station of the wireless network, which can recognize the correlation and determine configuration parameters for the wireless device accordingly. In some embodiments, the base station of the wireless network determines a correlation between two or more unadjusted parameters used for communication between the wireless device and a base station of the wireless network and sends to the wireless device a message indicating the determined correlation between the two or more unadjusted parameters. The wireless device can account for the determined correlation and can calculate one or more adjusted parameter values to send to the base station of the wireless network based on the determined correlation. In some embodiments, the base station determines a correlation between two or more unadjusted parameters based on feedback from the wireless device and indicates the correlation and/or adjusted parameter values to the wireless device.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to determine and use correlated parameter information for communication between a wireless device and a wireless network, according to some embodiments.

FIG. 2A illustrates a block diagram of exemplary communication between a wireless device and a base station of a cellular wireless network, according to some embodiments.

FIG. 2B illustrates a block diagram for calculation of a power headroom report (PHR) value by a wireless device, according to some embodiments.

FIGS. 3A and 3B illustrate diagrams of examples of conditions at a wireless device that limit cellular uplink transmission, according to some embodiments.

FIG. 4A illustrates a diagram of an example of a wireless device adjusting buffer status report (BSR) values provided to a base station of a wireless network, according to some embodiments.

FIG. 4B illustrates a diagram of an example of a wireless device dynamically determining and providing adjusted BSR values to a base station of a wireless network, according to some embodiments.

FIG. 4C illustrates a diagram of an example of new standardized BSR tables that include modifications based on PHR values, according to some embodiments.

FIG. 4D illustrates a diagram of an exemplary framework for dynamic correlated parameter exchange between a wireless device and a base station of a wireless network, according to some embodiments.

FIG. 5 illustrates a flowchart of an exemplary method performed by a wireless device for determining and using correlated parameter information for communication with a wireless network, according to some embodiments.

FIG. 6A illustrates a flowchart of another exemplary method performed by a wireless device for determining and using correlated parameter information for communication with a wireless network performed by a wireless device, according to some embodiments.

FIG. 6B illustrates flowcharts of a further exemplary method for determining and using correlated parameter information for communication between a wireless network and a wireless device, the method performed by a base station of the wireless network and by the wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

The described embodiments relate to wireless communications, including system, methods, and apparatus for determining, exchanging, and using correlated parameter information for communication between a wireless device and a base station of a wireless network. The wireless device and/or the base station can determine a correlation exists between different parameters communicated by the wireless device to the base station of the wireless network. The correlation can be taken into account when determining a configuration setting for the wireless device. In some cases, the wireless device determines a correlation and provides one or more adjusted parameter values to the base station of the wireless network. The adjusted parameter value can cause the base station of the wireless network to provide a configuration that better aligns with conditions present in the wireless device. In some cases, the wireless device determines adjusted parameter values using one or more pre-configured and/or dynamically configured tables. In some cases, the wireless device determines adjusted parameter values using pre-configured and/or dynamically configured algorithms. In some cases, the wireless device uses one or more machine learning algorithms to determine a correlation between parameters and/or to determine one or more adjusted parameter values to send to the base station of the wireless network. In some cases, one or more tables and/or one or more algorithms are customized for a particular wireless network with which the wireless device is in communication. In some embodiments, one or more tables are determined offline based on a history of unadjusted parameter values for one or more wireless devices in communication with the wireless network. In some cases, the wireless device determines a correlation and sends a message to the base station of the wireless network indicating the determined correlation. In some cases, the base station of the wireless network determines a correlation and sends a message to the wireless device indicating the determined correlation.

The wireless device can determine, or can be configured to recognize, a correlation between two distinct parameters communicated to the base station of the wireless network, e.g., between a buffer status report (BSR) value and a power headroom report (PHR) value. The wireless device can determine that both the BSR value and the PHR value together better represent conditions at the wireless device for transmitting uplink data than use of the BSR value alone and/or the PHR value independently. The wireless device can send to the base station of the wireless network an adjusted BSR value determined based on i) an amount of data pending in one or more buffers for uplink transmission and on ii) the PHR value. The adjusted BSR value can be lower than an unadjusted BSR value that would normally be sent to the base station of the wireless device in accordance with a wireless communication standard. In some embodiments, the wireless device determines an adjusted BSR value to send to the base station of the wireless network based on an amount of power available for the wireless device to use to transmit in the uplink direction. In some embodiments, the amount of power available is restricted by other computing elements of the wireless device, such as based on a thermal limitation for one or more components of the wireless device or based on a temporary high power consumption requirement for a component of the wireless device. By sending adjusted BSR values to the base station of the wireless network, the wireless device can better align an available amount of transmit power to resources granted by the base station to the wireless device. In some cases, the wireless device can determine that the base station of the wireless network overestimates an ability of the wireless device to transmit in the uplink direction based on a reported unadjusted BSR value. In some cases, the base station of the wireless network can be using unadjusted BSR values alone to determine uplink resource grant configurations for the wireless device. To reduce the probability of being configured with an overly optimistic resource grant, the wireless device can send an adjusted BSR value that accounts more closely with available transmit power of the wireless device in place of an unadjusted BSR value. In some embodiments, the wireless device determines one or more adjusted parameter values, such as an adjusted BSR value, based on a bit error rate (BER) and/or a block error rate (BLER).

In some embodiments, the wireless device the wireless device determines a correlation between two or more unadjusted parameters used for communication between the wireless device and a base station of the wireless network and sends to the base station of the wireless network a message indicating the determined correlation. The wireless device can send one or more adjusted parameter values to the base station of the wireless network, which can recognize the correlation and determine configuration parameters for the wireless device accordingly. In some embodiments, the base station of the wireless network determines a correlation between two or more unadjusted parameters used for communication between the wireless device and the base station of the wireless network and sends to the wireless device a message indicating the determined correlation between the two or more unadjusted parameters. The wireless device can account for the determined correlation and can calculate one or more adjusted parameter values to send to the base station of the wireless network based on the determined correlation. In some embodiments, the base station of the wireless network determines one or more adjusted parameter values based on a determined correlation between two or more unadjusted parameters used for communication between the wireless device and the base station, where the correlation can be determined by the wireless device and reported to the base station or can be determined by the base station based on information provided by the wireless device to the base station (and/or on other factors observed by the base station). In some embodiments, the base station sends one or more messages to the wireless device indicating one or more adjusted parameter values determined by the base station to configure the wireless device for communication with the base station. In some embodiments, a correlation is determined between two or more parameters at an access stratum (AS) layer by the wireless device and communicated to the base station of the wireless network via an AS layer radio resource control (RRC) connection. In some embodiments, a correlation is determined between two or more parameters at a non-access stratum (NAS) layer by the wireless device and communicated to the base station of the wireless network via a NAS layer uplink generic transport message. In some embodiments, a correlation is determined between two or more parameters at an AS layer by a base station of a wireless network and communicated to a wireless device via an AS layer RRC connection. In some embodiments, a correlation is determined between two or more parameters at a NAS layer by the base station of the wireless network and communicated to the wireless device via a page message.

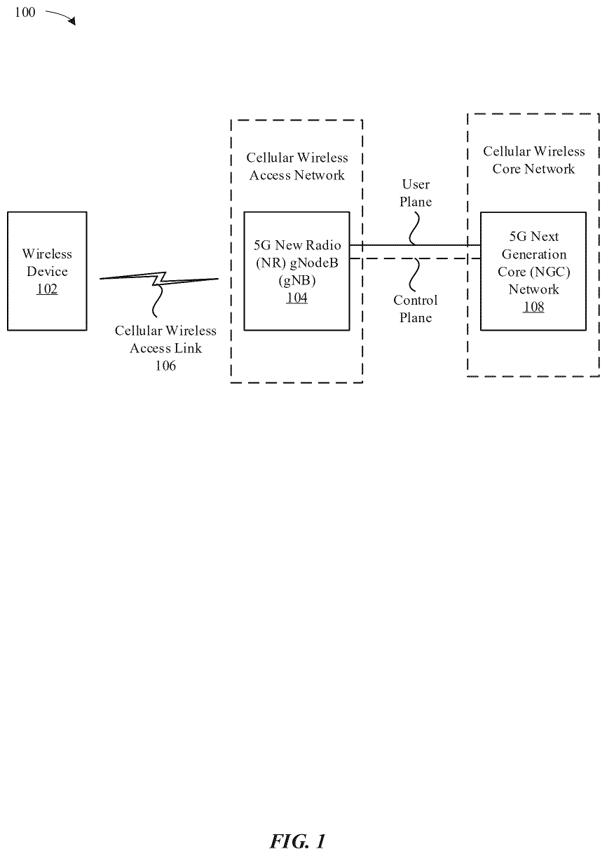

These and other embodiments are discussed below with reference to FIGS. 1 through 7; however, those skilled in the art will readily appreciate that the detailed description given herein with respect to these figures is for explanatory purposes only and should not be construed as limiting.

FIG. 1 illustrates a block diagram 100 of different components of a cellular wireless communication system that includes i) a wireless device 102, which can also be referred to as a mobile wireless device, a cellular wireless device, a wireless communication device, a mobile device, a user equipment (UE), a device, and the like, ii) a 5G NR gNodeB (gNB) 104, which is a network entity of a cellular wireless access network and can also be referred to herein as a base station or network base station, and iii) a 5G next generation core (NGC) network 108. The wireless device 102 can represent a mobile computing device (e.g., a phone, a tablet, a peripheral device, etc.). The 5G NR gNB 104 can be a single entity, quasi-collocated entities, or separated among multiple units (e.g., Central Units (CUs), Distributed Units (DUs), Remote Units (RUS)). Applications resident on the wireless device 102 can advantageously access services of a cellular wireless network using 5G NR connections via the 5G NR gNB 104. Communication between the wireless device 102 and the 5G NR gNB 104 over a cellular wireless access link 106 can be configured by the 5G NR gNB 104 based on one or more parameters communicated between the wireless device 102 and the 5G NR gNB 104. One exemplary parameter includes a buffer status report (BSR) value that indicates an amount of data pending in buffers of the wireless device 102 for transmission in an uplink direction from the wireless device 102 to the 5G NR gNB 104. The 5G NR gNB 104 of the cellular wireless network can use the BSR value to determine an amount of radio resources to allocate to the wireless device 102 for uplink transmission. Another exemplary parameter includes a power headroom report (PHR) value that is valid for a particular component carrier on which the wireless device is scheduled for uplink transmission during a particular time period. The PHR value depends on i) a maximum transmit power for the wireless device 102 on the particular component carrier according to a device type of the wireless device 102, where the maximum transmit power can be denoted as P_CMAX, and on ii) a calculated transmit power level for uplink transmission on the particular component carrier assuming no upper limit for transmission by the wireless device 102, where the calculated transmit power level can be denoted as P_PUSCH. The PHR value is calculated as the difference between P_CMAX and P_PUSCH. The 5G NR gNB 104 of the cellular wireless network can also use the PHR value to determine the amount of radio resources to allocate to the wireless device 102 for uplink transmission. The amount of radio resources allocated to the wireless device 102 can be specified based on a combination of a resource size allocation of time/frequency/space resources to the wireless device 102 and on a modulation-and-coding scheme (MCS) value for the wireless device 102 to use when communicating using the radio resources granted to the wireless device 102 by the 5G NR gNB 104 of the cellular wireless network. While the examples described in this application are presented based on 5G NR wireless communication, the same ideas for modifying reported parameter values, such as a BSR value, for using modified tables unilaterally (at the wireless device 102) or bilaterally (at both the wireless device 102 and in the wireless network), for determining correlation between parameters using machine learning by the wireless device 102 and/or a base station of a wireless network, and for exchanging determined parameter correlations between a wireless device 102 and a base station of a wireless network can apply to next generation 5G wireless communication and the like.

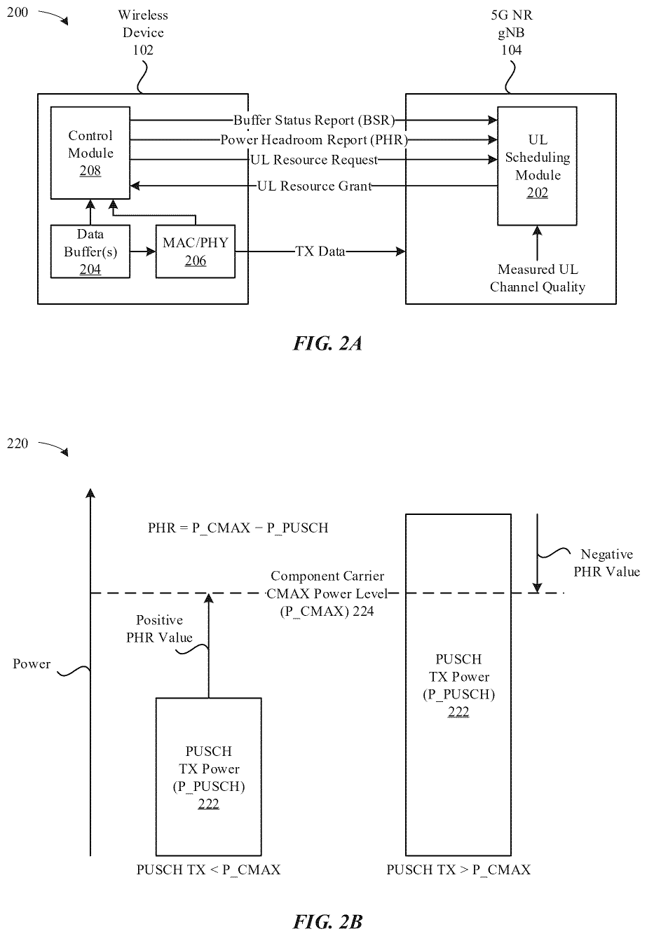

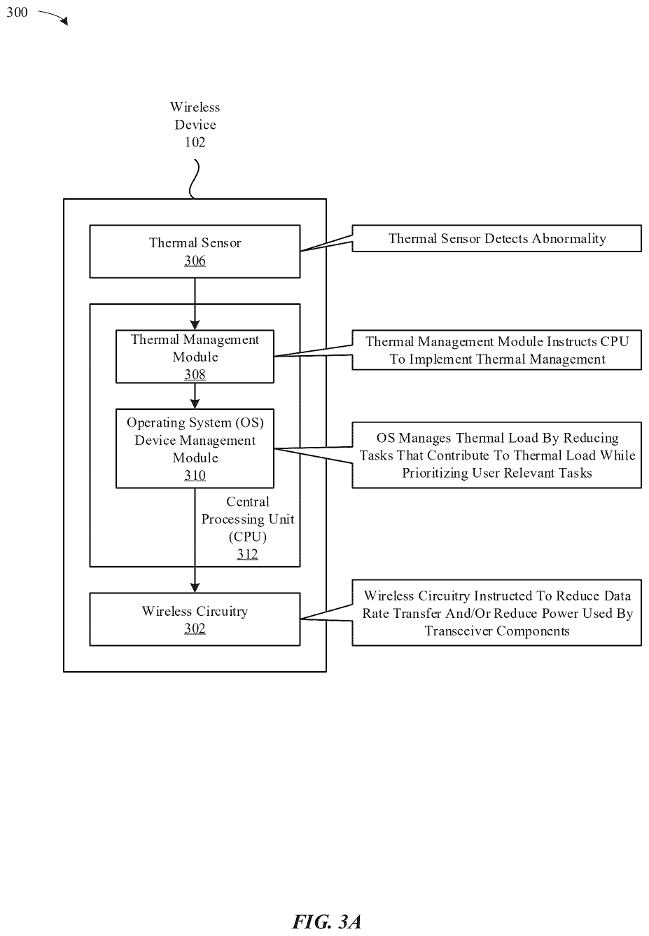

FIG. 2A illustrates a block diagram 200 of exemplary communication between a wireless device 102 and a 5G NR gNB 104 of a cellular wireless network. A control module 208 of the wireless device 102 can monitor status of one or more data buffers 204 as well as additional components used for wireless communication by the wireless device 102, e.g., physical (PHY) layer and medium access control (MAC) layer modules of baseband wireless circuitry, indicated as MAC/PHY 206 in FIG. 2A. The control module 208 can determine an amount of data pending for uplink transmission in the data buffer(s) 204 and can provide a buffer status report (BSR) value to the 5G NR gNB 104. The wireless device 102 sends the BSR value in an uplink (UL) MAC control element (CE) to indicate to the 5G NR gNB 104 a size of an UL grant that the wireless device 102 requires to transmit the pending uplink data. In some cases, the BSR value can be included in an UL resource request sent to the 5G NR gNB 104. Additionally, the control module 208 can determine a power headroom report (PHR) value based on a difference between a maximum transmit power P_CMAX and a calculated transmit power level for a physical uplink shared channel (PUSCH), the calculated transmit power level denoted as P_PUSCH. The PHR value indicates to the 5G NR gNB 104 an amount of transmit power available on the wireless device 102 for uplink transmissions. Presently, a wireless device 102 determines the BSR value to send based on a standardized look-up table that maps pending buffer data amounts to BSR values (indices). The standardized look-up table does not account for local conditions at the wireless device 102, (other than pending uplink data amounts), which can impact the ability of the wireless device 102 to transmit the pending uplink data reliably to the 5G NR gNB 104. Exemplary local conditions include radio frequency (RF) conditions, network traffic, and local power constraints.

Generally, there is an over-estimation by an UL scheduling module 202 of the 5G NR gNB 104 when determining a size of UL resource grant to provide to the wireless device 102 based on the BSR value provided by the wireless device 102. In some cases, the UL scheduling module 202 of the 5G NR gNB 104 may use a PHR value provided at different times than the BSR value (and therefore may be not accurately up-to-date for the BSR value used for UL grant determination). In some cases, the UL scheduling module 202 of the 5G NR gNB 104 may not use the PHR value and only use the BSR value when determining the size of the uplink resource grant. Scheduling algorithms used by base stations in different cellular wireless networks can vary. The 5G NR gNB 104 can also seek to maximize transmission capacity for the wireless device 102 and provide an UL resource grant sufficient for the pending uplink data. The wireless device 102 is required to transmit in accordance with the configuration parameters of the UL resource grant provided by the 5G NR gNB 104. In some circumstances, the wireless device 102 is limited to a transmit power level that can impact the ability of the uplink data to be received and decoded reliably by the 5G NR gNB 104. Inadequate available transmit power for cellular uplink transmission can result in decoding failures of transmitted uplink data at the 5G NR gNB 104. Decoding failures can result in multiple retransmissions of the same uplink data which reduces efficiency of transmission and wastes network resources. The 5G NR gNB 104 can measure UL channel quality and detect decoding errors, e.g., a first transmit block error rate (BLER) or an overall transmit BLER, and can re-adjust future UL grants provided to the wireless device 102 to reduce the probability of decoding errors, e.g., by changing a modulation-and-coding scheme (MCS) value and/or by changing a radio bearer. To achieve stability of UL transmission using observed BLER and UL grant re-adjustments takes some time and can interfere with the UL data transmission by the wireless device 102. As discussed herein, the wireless device 102, which has knowledge of local conditions that are up-to-date and/or are not known to the 5G NR gNB 104, can determine an adjusted BSR value to send to the 5G NR gNB 104, e.g., based on the PHR value, based on an estimated transmit power available for cellular wireless circuitry, and/or based on other parameters relevant to limiting uplink cellular transmission by the wireless device 102.

FIG. 2B illustrates a block diagram 220 for calculation of a PHR value by a wireless device 102. The PHR value is determined as a difference between i) a maximum transmit power for the wireless device 102 on a particular component carrier according to a device type of the wireless device 102, where the maximum transmit power is denoted as P_CMAX 224, and ii) a calculated transmit power level for uplink transmission on the particular component carrier assuming no upper limit for transmission by the wireless device 102, where the calculated transmit power level is denoted as P_PUSCH 222. The calculated transmit power level P_PUSCH 222 is theoretical and does not account for limitations of the wireless device 102. As shown in FIG. 2B, the PHR value can be positive, when P_CMAX 224 exceeds P_PUSCH 222, or the PHR value can be negative, when P_PUSCH 222 exceeds P_CMAX 224. The P_CMAX 224 value can depend on a type of wireless device 102, e.g., a cellular capable laptop computer, a mobile phone, and a cellular capable wearable device can each have different P_CMAX 224 values assigned to them by the 5G NR gNB 104 of the wireless network to which they are connected. As such, the 5G NR gNB 104 can have knowledge of the P_CMAX 224 value for the wireless device 102. The P_CMAX 224 value, however, may overestimate an amount of transmit power actually available for use by cellular wireless circuitry of the wireless device 102, due to other conditions present on the wireless device 102. The PHR value is directly related to the P_CMAX 224 value and the P_PUSCH 222 value. The BSR value is negatively correlated with the PHR value, as the amount of data transmitted increases, the power required to transmit the data also increases which decreases the PHR value. In addition, power available for transmission on the wireless device 102 can depend on more than just the amount of data to be transmitted, including limitations that are not controlled by the wireless circuitry of the wireless device 102.

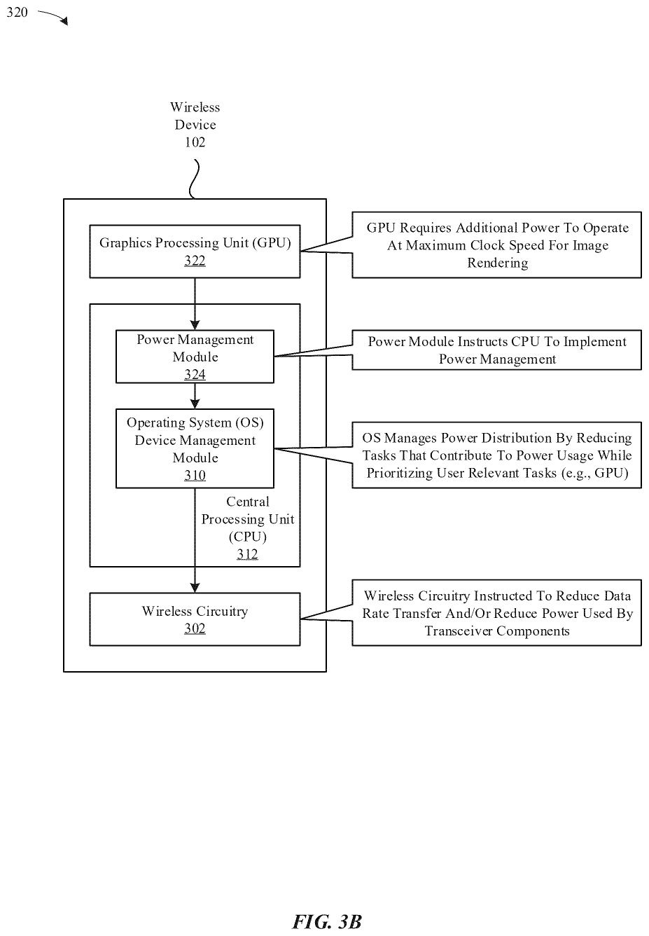

FIG. 3A illustrates a diagram 300 of an exemplary condition at a wireless device 102 that limits cellular uplink transmission. A thermal sensor 306 of the wireless device 102 can detect a temperature abnormality, e.g., a temperate of a component reaching or exceeding a temperature threshold level. The thermal sensor 306 can provide temperature information and/or other indications of the thermal abnormality to a thermal management module 308, which can be operable on a central processing unit (CPU) 312 of the wireless device 102. In some cases, the CPU 312 is an applications processor on which an operating system (OS) and user applications can execute. The thermal management module 308 can instruct an OS device management module 310, also resident on the CPU 312, to implement one or more thermal management processes. The OS device management module 310 can manage the thermal load of the wireless device 102 (at least in part) by reducing tasks that contribute to the thermal load while prioritizing user relevant tasks. In some cases, the OS device management module 310 instructs wireless circuitry 302 of the wireless device 102 to reduce data rate transfer and/or to reduce power used by transceiver components of the wireless circuitry 302. The wireless circuitry 302 can therefore be limited in uplink transmission capability (e.g., data rate, transmit power level, etc.) based on the thermal abnormality. With present methods, this limitation is not reflected in the BSR value or in the PHR value provided to the 5G NR gNB 104 by the wireless device 102. By adjusting a BSR value provided to the 5G NR gNB 104, the wireless device 102 can account for local condition limitations that impact uplink transmission capability of the wireless device 102.

FIG. 3B illustrates a diagram 320 of another exemplary conditions at a wireless device 102 that limits cellular uplink transmission. A graphic processing unit (GPU) 322 of the wireless device 102 can require additional power to operate at a maximum clock speed for a currently executing (or to be executed) process, e.g., for image rendering. The GPU 322 can indicate the requirement for the maximum clock speed and/or for additional power consumption to a power management module 324 operable on a CPU 312 of the wireless device 102. The power management module 324 can instruct an OS device management module 310 CPU 312 to implement a power management procedure. The OS device management module 310 can manage power distribution in the wireless device 102 by reducing certain tasks that contribute to power usage while prioritizing user relevant tasks, e.g., tasks of the GPU 322. In some cases, the OS device management module 310 instructs wireless circuitry 302 of the wireless device 102 to reduce data rate transfer and/or to reduce power used by transceiver components of the wireless circuitry 302. The wireless circuitry 302 can therefore be limited in uplink transmission capability (e.g., data rate, transmit power level, etc.) based on computational and/or power requirements of other components of the wireless device 102. With present methods, this limitation is not reflected in the BSR value or in the PHR value provided to the 5G NR gNB 104 by the wireless device 102. As with thermal limitations discussed hereinabove, by adjusting a BSR value provided to the 5G NR gNB 104, the wireless device 102 can account for local condition limitations that impact local uplink transmission capability of the wireless device 102.

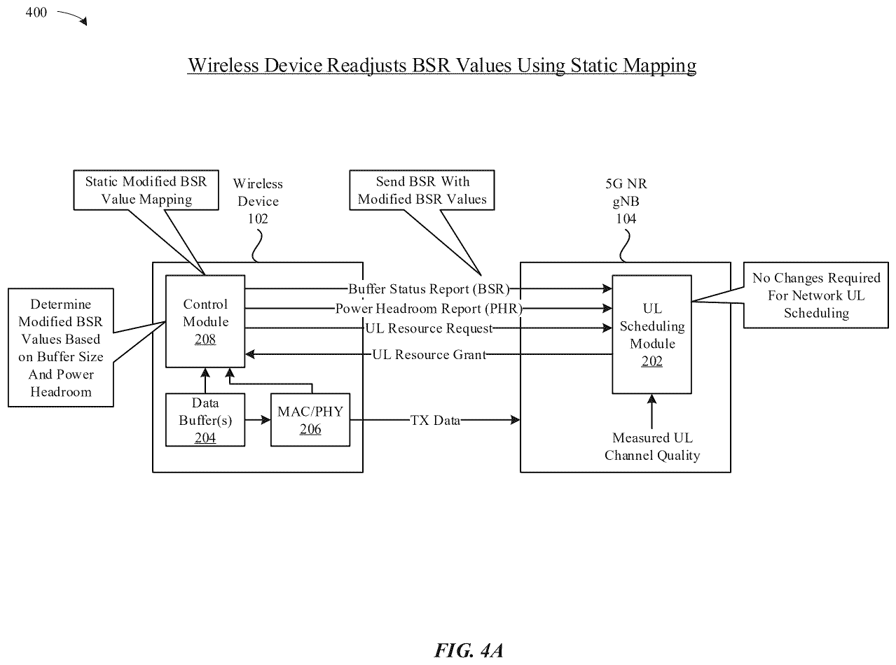

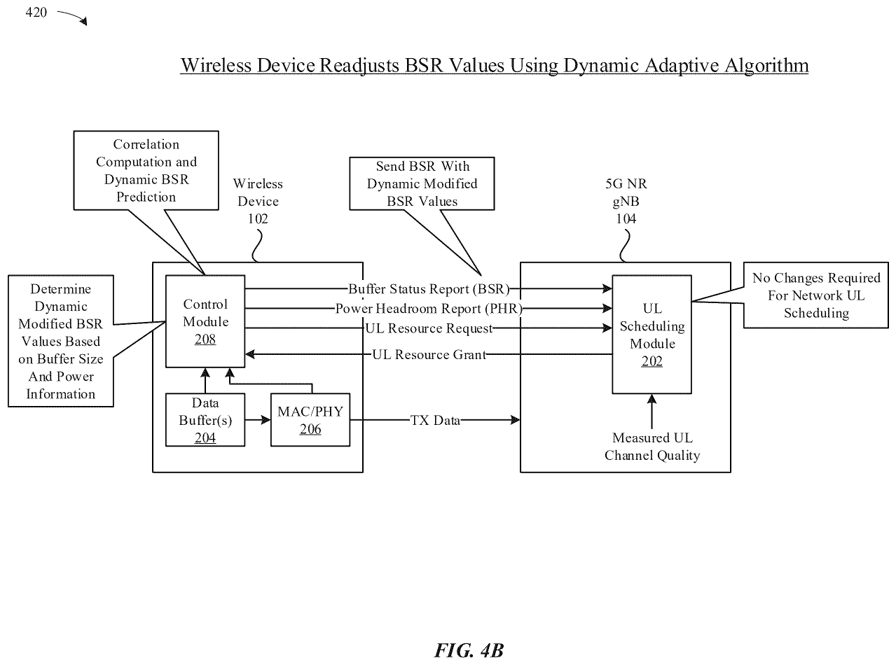

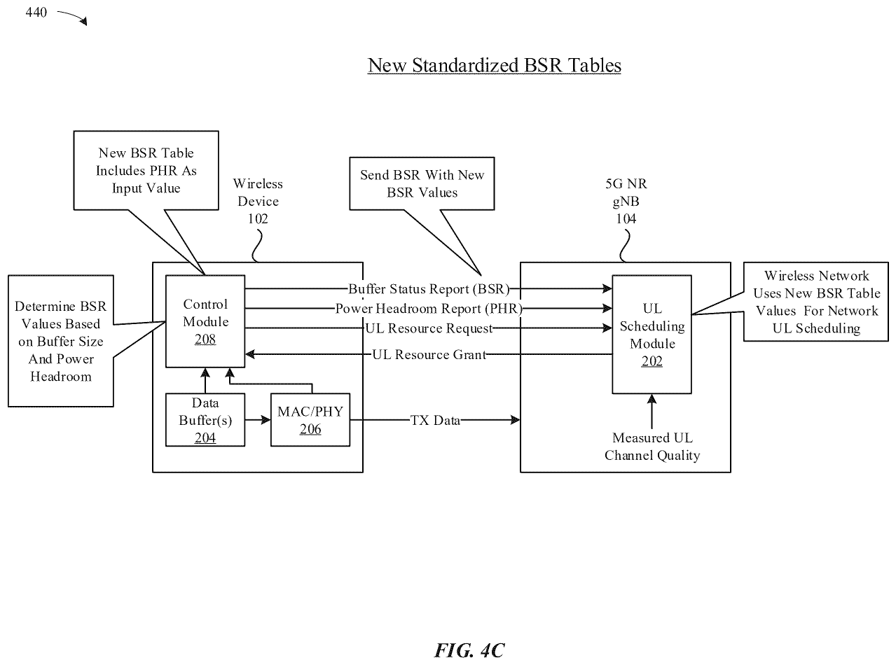

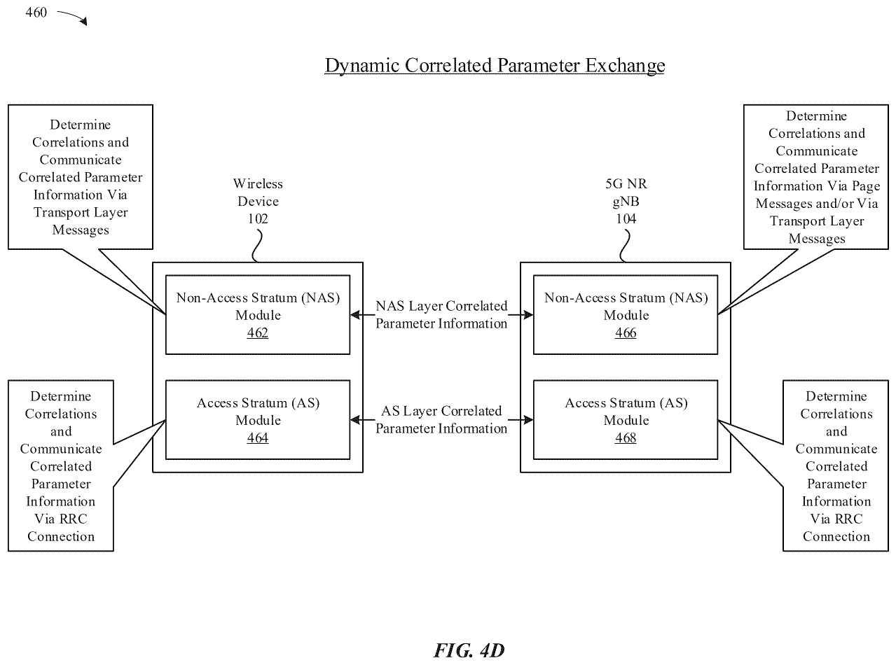

FIG. 4A illustrates a diagram 400 of an example of a wireless device 102 adjusting BSR values provided to a base station of a wireless network. A control module 208 of the wireless device 102 can determine a modified (adjusted, re-adjusted) BSR value based on both i) an amount of data in one or more data buffers 204 pending uplink transmission to a 5G NR gNB 104 of a cellular wireless network and ii) a power headroom report (PHR) value, which can provided by wireless circuitry, such as a baseband processor that includes a MAC/PHY module 206 for processing wireless data and signal transmissions. The control module 208 can also be part of the wireless circuitry, e.g., operable within a baseband processor of the wireless device 102, in some embodiments. In some cases, the control module 208 is operable on a separate processor, e.g., an applications processor, of the wireless device 102. The control module 208 can send modified BSR values in the BSR to the UL scheduling module 202 of the 5G NR gNB 104. Whether to modify a BSR value can depend on a concurrent (or recent) PHR value (or based on another power calculation) that accounts for an amount of transmit power available for the wireless device 102 to use for uplink data transmission. In some cases, for certain PHR values, the modified BSR value can be lower than an unmodified BSR value that would normally be sent. In some cases, for certain PHR values, the modified BSR value can be the same as an unmodified BSR value. In some embodiments, the control module 208 uses a preloaded table to determine a modified BSR value to send to the 5G NR gNB 104 based on both an unmodified BSR value and on an associated PHR value. In some cases, the control module 208 uses additional power control information, such as whether thermal limitations or other computational component requirements limit the available transmit power to determine a modified BSR value to send to the 5G NR gNB 104. No changes to procedures for determining UL scheduling, including UL grants based on BSR values, are required by the 5G NR gNB 104. By sending a modified (e.g., lower) BSR value rather than an unmodified BSR value, when certain power limitations exist at the wireless device 102 (which can be ascertained at least in part, in some cases, based on a concurrent/recent PHR value), the UL scheduling module 202 is expected to assign an UL grant to the wireless device 102 that matches current conditions for uplink transmit power at the wireless device 102.

FIG. 4B illustrates a diagram 420 of an example of a wireless device 102 dynamically determining and providing adjusted BSR values to a base station of a wireless network. A control module 208 of the wireless device 102 can determine a correlation exists between two or more parameters used by the wireless device 102 and that influence uplink transmission, e.g., impact available transmit power. In some cases, the control module determines a set of parameters that are correlated using a machine learning (ML) algorithm, such as a long short-term memory (LSTM) recurrent neural network deep learning algorithm to identify correlations between parameters and dynamically predict a modified BSR value to be sent to the UL scheduling module 202 of the 5G NR gNB 104. In some cases, the control module 208 determines a dynamically modified BSR value based on a BSR prediction obtained from observed correlations between various parameters. In some cases, a history of parameter values, such as BSR values, PHR values, BER values, BLER values, power limitations, etc., can be processed to determine a BSR value that best suits conditions for the wireless device 102. In some cases, a determined BSR value can depend on how the 5G NR gNB 104 assigns UL grants to the wireless device 102 responsive to BSR values and/or PHR values provided by the wireless device 102 to the UL scheduling module 202 of the 5G NR gNB 104. In some cases, the wireless device 102 identifies a set of correlated parameters at the wireless device 102 and associates particular dynamic BSR values to different sets of correlated parameter values (e.g., a multi-dimensional mapping between a set of parameter values and a dynamic modified BSR value). In some cases, a history of correlated parameter values can be limited to a recent past, e.g., 50 to 100 most recent values, and can accurately be used to predict an appropriate dynamic modified BSR value to send to the 5G NR gNB 104. In some cases, the control module 208 determines a dynamically modified BSR value based on both i) an amount of data in one or more data buffers 204 pending uplink transmission to a 5G NR gNB 104 of a cellular wireless network and on ii) one or more power limitations in the wireless device 102 that impact uplink wireless data and signal transmission. The control module 208 can be part of the wireless circuitry, e.g., operable within a baseband processor of the wireless device 102, in some embodiments. In some cases, the control module 208 is operable on a separate processor, e.g., an applications processor, of the wireless device 102. The control module 208 can send dynamic modified BSR values in the BSR to the UL scheduling module 202 of the 5G NR gNB 104. Generally, the dynamic modified BSR value can be equal to or lower than an unmodified BSR value that would normally be sent. In some cases, the control module 208 uses additional power control information, such as whether thermal limitations or other computational component requirements limit the available transmit power to determine a dynamic modified BSR value to send to the 5G NR gNB 104. No changes to procedures for determining UL scheduling, including UL grants based on BSR values, are required by the 5G NR gNB 104. By sending a dynamic modified (e.g., lower) BSR value rather than an unmodified BSR value, when certain conditions exist at the wireless device 102 (which can be ascertained at least in part, in some cases, based correlation computations performed via machine learning), the UL scheduling module 202 is expected to assign an UL grant to the wireless device 102 that matches current conditions for uplink transmit power at the wireless device 102.

FIG. 4C illustrates a diagram 440 of an example of new standardized BSR tables that include modifications based on PHR values. Both the wireless device 102 and the 5G NR gNB 104 can be use new BSR tables that include PHR values. In some cases, only a portion of the new standardized BSR tables are modified based on PHR values, e.g., for those PHR values that have been observed to impact performance for a wireless device 102 of a particular device category. In some cases, different BSR tables can be used for different device categories. The 5G NR gNB 104 can know that the wireless device 102 is using the new BSR tables that include a PHR value as an input to determine a BSR value to send to the 5G NR gNB 104 of the wireless network. The control module 208 of the wireless device 102 can determine BSR values using the new standardized tables based on both pending uplink data buffer size and on a PHR value. In some cases, the UL scheduling module 202 uses the new BSR table to determine UL grants to send to the wireless device 102.

FIG. 4D illustrates a diagram 460 of an exemplary framework for dynamic correlated parameter exchange between a wireless device 102 and a 5G NR gNB 104. The wireless device 102 and/or the 5G NR gNB 104 can determine correlations between parameters and provide correlated parameter information between them. In some embodiments, an access stratum (AS) module 464 of the wireless device 102 and an AS module 468 of the 5G NR gNB 104 can indicate to each other a capability to exchange parameter (sub-parameter) correlations, e.g., via a radio resource control (RRC) parameter value that indicates whether parameter correlation capability is available, e.g., a binary true/false RRC parameter value indicating the capability. In some cases, a list of parameters that can be considered applicable for determining correlation can be exchanged. In some cases, a list of parameters applicable for determining correlation can be preset by a wireless communication standard and preloaded in the wireless device 102 and the 5G NR gNB 104. In some cases, a list of parameters that can potentially be correlated with a given parameter can also be exchanged or predetermined and preloaded. Thus, the wireless device 102 and the 5G NR gNB 104 can each be aware of the total set of parameters that may have correlations, and for each parameter the particular parameters that can may be correlated with that parameter. In some embodiments, the AS module 464 of the wireless device 102 observes parameter values at the AS layer, e.g., using a machine learning process, determines one or more correlations between parameters, and communicates correlated parameter information to the AS module 468 of the 5G NR gNB 104 via an RRC connection. In some embodiments, the AS module 468 of the 5G NR gNB 104 observes parameter values at the AS layer, e.g., using a machine learning process, determines one or more correlations between parameters, and communicates correlated parameter information to the AS module 464 of the wireless device 102 via an RRC connection.

In some embodiments, a non-access stratum (NAS) module 462 of the wireless device 102 and a NAS module 466 of the 5G NR gNB 104 can each observe parameter values and determine correlated parameter information applicable to the NAS layer. In some embodiments, the NAS module 462 of the wireless device 102 observes parameter values at the NAS layer, e.g., using a machine learning process, determines one or more correlations between parameters, and communicates correlated parameter information to the NAS module 466 of the 5G NR gNB 104 via an uplink (UL) generic NAS transport message. In some embodiments, the NAS module 466 of the 5G NR gNB 104 observes parameter values at the NAS layer, e.g., using a machine learning process, determines one or more correlations between parameters, and communicates correlated parameter information to the NAS module 462 of the wireless device 102 via a page message and/or via a downlink (DL) generic NAS transport message. In some embodiments, messages can be communicated that indicate observed correlations between AS layer parameters and NAS layer parameters.

In some embodiments, a wireless device 102 communicates an update to a table used for determination of UL grants to a base station of a wireless network. In some embodiments, different sets of parameter values are pre-stored at the wireless device 102 and at the base station of the wireless network, and the wireless device 102 indicates which set of parameter values to be used, e.g., in an RRC reconfiguration message. In some embodiments, the wireless device 102 determines correlation between two or more parameters and determines one or more adjusted parameter values to use for communication with a base station of a wireless network. In some embodiments, the wireless device 102 provides determined parameter correlation information and/or adjusted parameter values to the base station of the wireless network, e.g., using AS layer messages and/or NAS layer messages. In some embodiments, the wireless device 102 provides feedback to a base station of a wireless network, and the base station determines correlation between two or more parameters used for communication between the wireless device 102 and the base station of the wireless network based at least in part on feedback from the wireless device 102. In some embodiments, the base station provides determined parameter correlation information and/or adjusted parameter values to the wireless device 102, e.g., using AS layer messages and/or NAS layer messages.

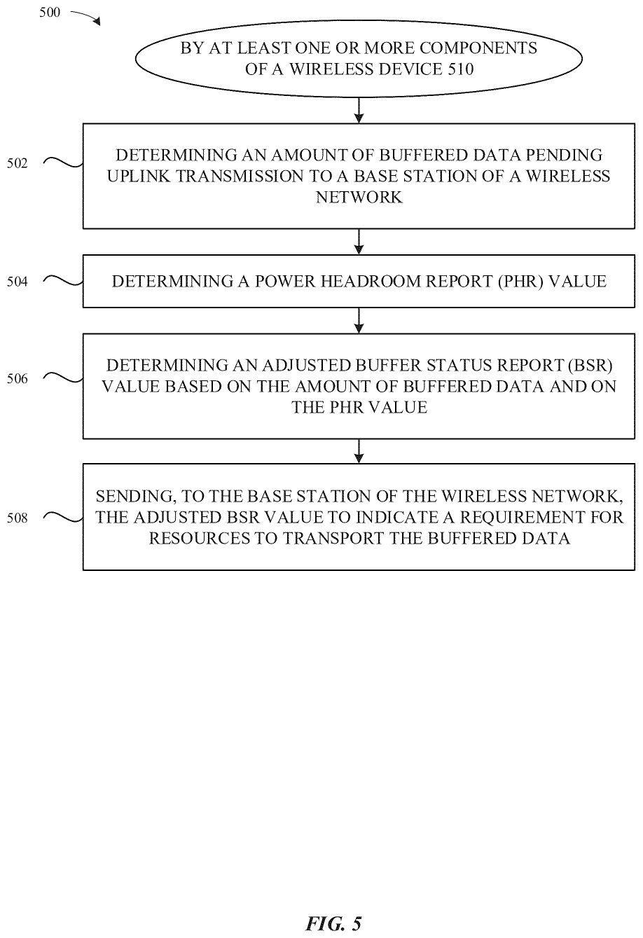

FIG. 5 illustrates a flowchart 500 of an exemplary method performed by at least one or more components of a wireless device 510 for determining and using correlated parameter information for communication with a wireless network. An exemplary embodiment of wireless device 510 can be wireless device 102 and/or one or more components of the wireless device 102 (e.g., control module 208, data buffer(s) 204, MAC/PHY module 206, thermal sensor 306, CPU 312, GPU 322, wireless circuitry 302, thermal management module 308, OS device management module 310, power management module 324, NAS module 462, AS module 464, etc.) At 502, the method includes determining an amount of buffered data pending uplink transmission to a base station of the wireless network. At 504, the method includes determining a power headroom report (PHR) value. At 506, the method includes determining an adjusted buffer status report (BSR) value based on the amount of buffered data and on the PHR value. At 508, the method includes sending, to the base station of the wireless network, the adjusted PHR value to indicate a requirement for resources to transport the buffered data.

In some embodiments, the adjusted BSR value differs from a corresponding unadjusted BSR value for the amount of buffered data according to a wireless communication protocol used by the wireless device. In some embodiments, the adjusted BSR value is based on one or more additional parameters determined to be correlated with the unadjusted BSR value by the wireless device. In some embodiments, the one or more additional parameters include a bit error rate (BER) value or a block error rate (BLER) value. In some embodiments, the adjusted BSR value is based on an amount of transmit power available to the wireless device for uplink transmission. In some embodiments, the amount of transmit power is restricted by the wireless device to less than a maximum power value (PC_Max) corresponding to a device type for the wireless device. In some embodiments, the amount of transmit power is restricted based on an operating temperature of one or more components of the wireless device. In some embodiments, the amount of transmit power is restricted based on a power requirement for another computational unit of the wireless device. In some embodiments, determination of the adjusted BSR value includes obtaining from a table the adjusted BSR value, where the table includes one or more adjusted BSR values that differ from corresponding non-adjusted BSR values for amounts of buffered data. In some embodiments, the one or more adjusted BSR values included in the table are customized for the wireless network. In some embodiments, the table is determined offline based on a history of unadjusted BSR values and corresponding PHR values from one or more wireless devices in communication with the wireless network.

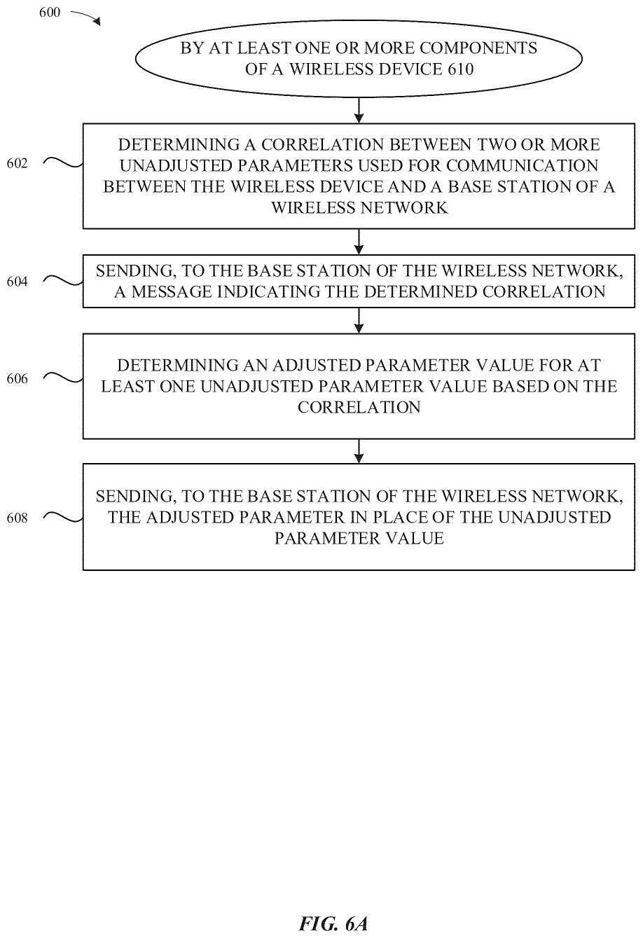

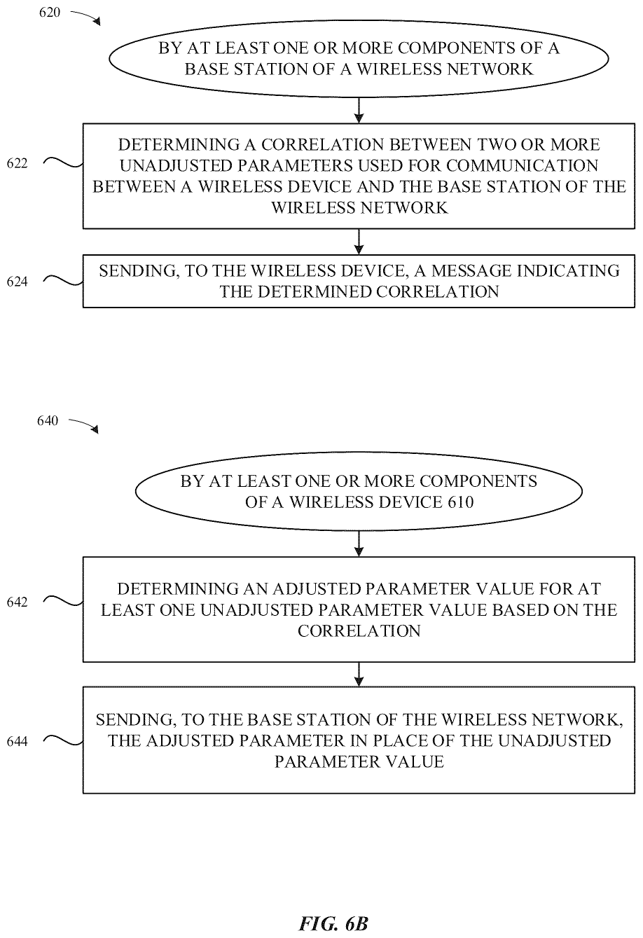

FIG. 6A illustrates a flowchart 600 of another exemplary method performed by at least one or more components of a wireless device 610 for determining and using correlated parameter information for communication with a wireless network. An exemplary embodiment of wireless device 610 can be wireless device 102 and/or one or more components of the wireless device 102 (e.g., control module 208, data buffer(s) 204, MAC/PHY module 206, thermal sensor 306, CPU 312, GPU 322, wireless circuitry 302, thermal management module 308, OS device management module 310, power management module 324, NAS module 462, AS module 464, etc.) At 602, the method includes determining a correlation between two or more unadjusted parameters used for communication between the wireless device 610 and a base station of the wireless network. At 604, the method includes sending, to the base station of the wireless network, a message indicating the determined correlation. At 606, the method includes determining an adjusted parameter value for at least one unadjusted parameter value based on the correlation. At 608, the method includes sending, to the base station of the wireless network, the adjusted parameter in place of the unadjusted parameter value. In some embodiments, the correlation is determined between two unadjusted parameters at an access stratum (AS) layer, and the message is sent to the base station by the wireless device 610 via an AS layer radio resource control (RRC) connection. In some embodiments, the correlation is determined between two unadjusted parameters at a non-access stratum (NAS) layer, and the message is sent to the base station by the wireless device 610 via a NAS layer uplink generic transport message.

FIG. 6B illustrates flowcharts 620, 640 of a further exemplary method for determining and using correlated parameter information for communication between a wireless network and a wireless device, the method performed by at least one or more components of a base station of the wireless network and by at least one or more components of a wireless device 610. At 622, the method includes determining, by at least one or components of the base station, a correlation between two or more unadjusted parameters used for communication between the wireless device 610 and the base station of the wireless network. At 624, the method further includes sending, by the one or more components of the base station of the wireless network, to the wireless device 102, a message indicating the determined correlation. At 642, the method includes determining, by at least one or more components of the wireless device 610, an adjusted parameter value for at least one unadjusted parameter value based on the correlation. At 644, the method further includes sending, by the at least one or more components of the wireless device 610, to the base station of the wireless network, the adjusted parameter value in place of the unadjusted parameter value. In some embodiments, the correlation is determined between two unadjusted parameters at an access stratum (AS) layer, and the message is sent to the wireless device 610 by the base station via an AS layer radio resource control (RRC) connection. In some embodiments, the correlation is determined between two unadjusted parameters at a non-access stratum (NAS) layer, and the message is sent to the wireless device 610 by the base station via a NAS layer downlink generic transport message. In some embodiments, the correlation is determined between two unadjusted parameters at a non-access stratum (NAS) layer, and the message is sent to the wireless device 610 by the base station via a page message.

### Representative Exemplary Apparatus

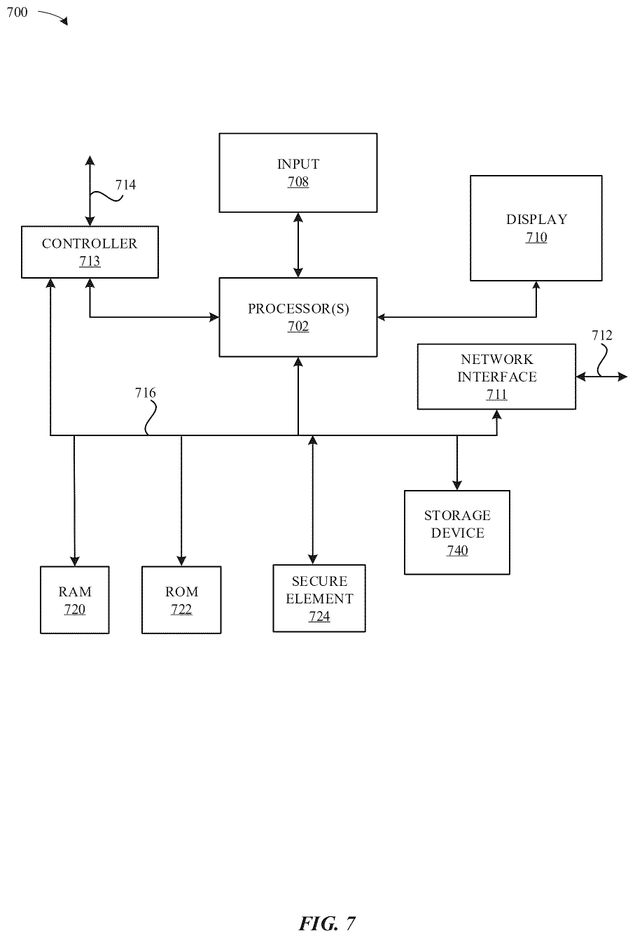

FIG. 7 illustrates in block diagram format an exemplary computing device 700 that can be used to implement the various components and techniques described herein, according to some embodiments. In particular, the detailed view of the exemplary computing device 700 illustrates various components that can be included in the wireless device 102. As shown in FIG. 7, the computing device 700 can include one or more processors 702 that represent microprocessors or controllers for controlling the overall operation of computing device 700 and/or particular functions of the computing device 700, e.g., an applications processor, a baseband processor, a power control processor, etc. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband component. The computing device 700 can also include a secure element 724. The secure element 724 can include an eUICC and/or one or more UICCs.

The computing device 700 also includes a storage device 740, which can include a single storage or a plurality of storages (e.g., hard drives and/or solid-state drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An apparatus comprising memory coupled to processing circuitry, the processing circuitry configured to:
determine an amount of buffered data pending uplink transmission to a base station of a wireless network;
determine a power headroom report (PHR) value;
determine an adjusted buffer status report (BSR) value based on the amount of buffered data and on the PHR value; and
send the adjusted BSR value to the base station of the wireless network to indicate a requirement for resources to transport the buffered data.

2. The apparatus of claim 1, wherein the adjusted BSR value differs from a corresponding unadjusted BSR value for the amount of buffered data according to a wireless communication protocol.

3. The apparatus of claim 1, wherein the adjusted BSR value is based on one or more additional parameters determined to be correlated with an unadjusted BSR value.

4. The apparatus of claim 3, wherein the one or more additional parameters comprise a bit error rate (BER) value or a block error rate (BLER) value.

5. The apparatus of claim 1, wherein the adjusted BSR value is based on an amount of transmit power available for uplink transmission.

6. The apparatus of claim 5, wherein the amount of transmit power is restricted to less than a maximum power value (PC_Max) corresponding to a device type for a wireless device.

7. The apparatus of claim 6, wherein the amount of transmit power is restricted based on an operating temperature of one or more components.

8. The apparatus of claim 6, wherein the amount of transmit power is restricted based on a power requirement for another computational unit.

9. The apparatus of claim 1, wherein the circuitry is further configured to determine the adjusted BSR value by obtaining, from a table, the adjusted BSR value, wherein the table includes one or more adjusted BSR values that differ from corresponding non-adjusted BSR values for amounts of buffered data.

10. The apparatus of claim 9, wherein the one or more adjusted BSR values included in the table are customized for the wireless network.

11. The apparatus of claim 10, wherein the table is determined offline based on a history of unadjusted BSR values and corresponding PHR values from one or more wireless devices in communication with the wireless network.

12. The apparatus of claim 1, wherein the apparatus comprises a baseband processor and/or an application processor.

13. A method for determining and using correlated parameter information for communication with a wireless network, the method comprising:
by at least one or more components of a wireless device:
determining an amount of buffered data pending uplink transmission to a base station of the wireless network;
determining a power headroom report (PHR) value;
determining an adjusted buffer status report (BSR) value based on the amount of buffered data and on the PHR value; and
sending, to the base station of the wireless network, the adjusted BSR value to indicate a requirement for resources to transport the buffered data.

14. The method of claim 13, wherein the adjusted BSR value differs from a corresponding unadjusted BSR value for the amount of buffered data according to a wireless communication protocol used by the wireless device.

15. The method of claim 13, wherein the adjusted BSR value is based on an amount of transmit power available to the wireless device for uplink transmission.

16. The method of claim 15, wherein the amount of transmit power is restricted by the wireless device to less than a maximum power value (PC_Max) corresponding to a device type for the wireless device.

17. The method of claim 16, wherein the amount of transmit power is restricted based on one or more of: i) an operating temperature of one or more components of the wireless device, or ii) a power requirement for another computational unit of the wireless device.

18. A method for determining and using correlated parameter information for communication with a wireless network, the method comprising:
by at least one or more components of a wireless device:
determining a correlation between two or more unadjusted parameters used for communication between the wireless device and a base station of the wireless network;
sending, to the base station of the wireless network, a message indicating the determined correlation;
determining an adjusted parameter value for at least one unadjusted parameter value based on the correlation; and
sending, to the base station of the wireless network, the adjusted parameter value in place of the unadjusted parameter value.

19. The method of claim 18, wherein:
the correlation is determined between two unadjusted parameters at an access stratum (AS) layer; and
the message is sent to the base station by the wireless device via an AS layer radio resource control (RRC) connection.

20. The method of claim 18, wherein:
the correlation is determined between two unadjusted parameters at a non-access stratum (NAS) layer, and
the message is sent to the base station by the wireless device via a NAS layer uplink generic transport message.
